(19) United States
(12) Patent Application Publication
(10) Pub. No.: US 2019/0294874 A1
(43) Pub. Date: Sep. 26, 2019

(54) AUTOMATIC DEFINITION OF SET OF CATEGORIES FOR DOCUMENT CLASSIFICATION

(71) Applicant: ABBYY Production LLC, Moscow (RU)

(72) Inventors: Nikita Orlov, Chelyabinsk (RU); Konstantin Anisimovich, Moscow (RU)

(21) Appl. No.: 15/939,092

(22) Filed: Mar. 28, 2018

(30) Foreign Application Priority Data
Mar. 23, 2018 (RU) 2018110385

(51) Int. Cl. G06K 9/00; G06K 9/62; G06F 17/27; G06N 3/04

(52) U.S. Cl. CPC G06K 9/00463; G06K 9/00456; G06N 3/04; G06F 17/27; G06K 9/6218

(57) ABSTRACT

Systems and methods for automatic definition of natural language document classes. An example method comprises: producing, by a computer system, a plurality of image features by processing images of a plurality of documents; producing a plurality of text features by processing texts of a plurality of documents; producing a plurality of feature vectors, wherein each feature vector of the plurality of feature vectors comprises at least one of: a subset of the plurality of image features and a subset of the plurality of text features; clusterizing the plurality feature vectors to produce a plurality of clusters; defining a plurality of document categories, such that each document category of the plurality of document categories is defined by a respective feature cluster of the plurality of feature clusters; and training a classifier to produce a value reflecting a degree of association of an input document with one or more document categories of the plurality of document categories.

### REFERENCE TO RELATED APPLICATIONS

The present application claims the benefit of priority under 35 U.S.C. § 119 to Russian Patent Application No. 2018110385 filed Mar. 23, 2018, the disclosure of which is incorporated by reference herein.

### TECHNICAL HELD

The present disclosure is generally related to computer systems, and is more specifically related to systems and methods for natural language processing.

### BACKGROUND

Automatic processing of documents (e.g., images of paper documents or various electronic documents including natural language text) may involve classification of the input documents by associating a given document with one or more categories of a certain set of categories.

### SUMMARY OF THE DISCLOSURE

In accordance with one or more aspects of the present disclosure, an example method of automatically defining set of categories for document classification may include: producing a plurality of image features by processing images of a plurality of documents; producing a plurality of text features by processing texts of a plurality of documents; producing a plurality of feature vectors, wherein each feature vector of the plurality of feature vectors comprises at least one of: a subset of the plurality of image features and a subset of the plurality of text features; clusterizing the plurality feature vectors in order to produce a plurality of clusters; defining a plurality of document categories, such that each document category of the plurality of document categories is defined by a respective feature cluster of the plurality of feature clusters; and training a classifier in order to produce a value reflecting a degree of association of an input document with one or more document categories of the plurality of document categories.

In accordance with one or more aspects of the present disclosure, an example system for automatically defining set of categories for document classification may include a memory and a processor, coupled to the memory, the processor configured to: produce a plurality of image features by processing images of a plurality of documents; produce a plurality of text features by processing texts of a plurality of documents; produce a plurality of feature vectors, wherein each feature vector of the plurality of feature vectors comprises at least one of: a subset of the plurality of image features and a subset of the plurality of text features; clusterize the plurality feature vectors in order to produce a plurality of clusters; define a plurality of document categories, such that each document category of the plurality of document categories is defined by a respective feature cluster of the plurality of feature clusters; and train a classifier in order to produce a value reflecting a degree of association of an input document with one or more document categories of the plurality of document categories.

In accordance with one or more aspects of the present disclosure, an example computer-readable non-transitory storage medium may comprise executable instructions that, when executed by a computer system, cause the computer system to: produce a plurality of image features by processing images of a plurality of documents; produce a plurality of text features by processing texts of a plurality of documents; produce a plurality of feature vectors, wherein each feature vector of the plurality of feature vectors comprises at least one of: a subset of the plurality of image features and a subset of the plurality of text features; clusterize the plurality feature vectors in order to produce a plurality of clusters; define a plurality of document categories, such that each document category of the plurality of document categories is defined by a respective feature cluster of the plurality of feature clusters; and train a classifier in order to produce a value reflecting a degree of association of an input document with one or more document categories of the plurality of document categories.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example workflow for automatically defining set of categories for document classification, in accordance with one or more aspects of the present disclosure;

FIG. 2 depicts a flow diagram of one illustrative example of a method of automatically defining set of categories for document classification, in accordance with one or more aspects of the present disclosure;

FIG. 3 schematically illustrates operation of a convolutional neural network (CNN), in accordance with one or more aspects of the present disclosure;

FIG. 4 schematically illustrates a structure of an example autoencoder operating in accordance with one or more aspects of the present disclosure;

FIG. 5 schematically illustrates operation of an example autoencoder operating in accordance with one or more aspects of the present disclosure;

FIG. 6 schematically illustrates a structure of an example recurrent neural network operating in accordance with one or more aspects of the present disclosure;

FIG. 7 schematically illustrates applying an example document layout template to the input document, in accordance with one or more aspects of the present disclosure;

FIGS. 8A-8C schematically illustrate applying Principal Component Analysis (PCA) for normalizing concatenated feature vectors, in accordance with one or more aspects of the present disclosure;

FIG. 9 schematically illustrates utilizing an autoencoder for normalizing concatenated feature vectors, in accordance with one or more aspects of the present disclosure; and

FIG. 10 depicts a diagram of an example computer system implementing the methods described herein.

### DETAILED DESCRIPTION

Described herein are methods and systems for automatically defining set of categories for document classification.

Automatic processing of documents (e.g., images of paper documents or various electronic documents including natural language text) may involve classification of the input documents by associating a given document with one or more categories of a certain set of categories.

Document classification may be performed by evaluating one or more classification functions, also referred to as “classifiers,” each of which may be represented by a function of document features that yields the degree of association of the input document with a certain category of a specified set of categories. Thus, document classification may involve evaluating a set of classifiers corresponding to the set of categories, and associating the document with the category corresponding to the optimal (maximum or minimum) value among the values produced by the classifiers. In an illustrative example, the input documents may be classified into readily apparent high-level categories, such as agreements, photographs, questionnaires, certificates, etc. In another illustrative example, the categories may be less apparent, e.g., similarly structured documents, such as invoices, may be classified by the seller name.

Values of classifier parameters may be determined by supervised learning methods, which may involve iteratively modifying one or more parameter values based on analyzing a training data set including documents with known classification categories, in order to optimize a specified fitness function (e.g., reflecting the ratio of the number of documents of a validation data set that would be classified correctly using the specified values of the classifier parameters to the total number of the documents in the validation data set).

In practice, the number of available annotated documents which may be included into the training or validation data set may be relatively small, as producing such annotated documents involves receiving the user input specifying the classification category for each document. Supervised learning based on relatively small training and validation data sets may produce poorly performing classifiers.

Furthermore, various common implementations call upon a user for defining the very set of categories for document classification. However, the user may not always be capable to define a set of categories which would be best suitable for subsequent automatic information extraction from the documents being processed.

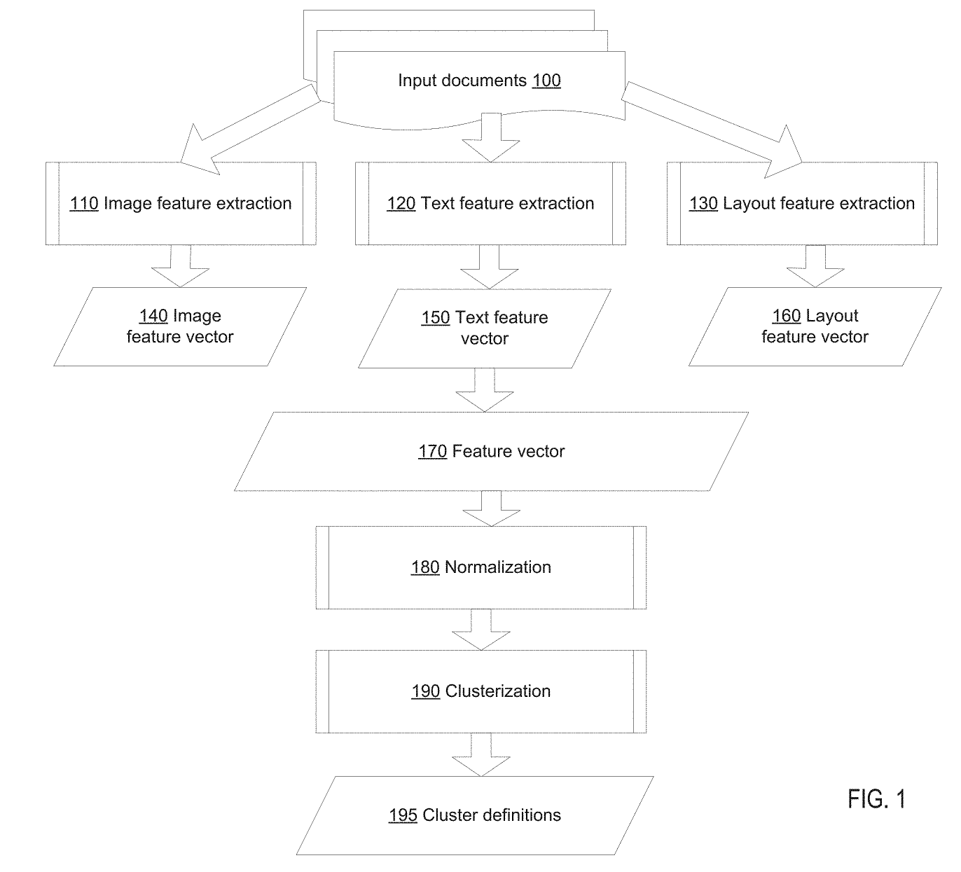

Accordingly, the present disclosure addresses the above-noted and other deficiencies of known document classification methods by providing systems and methods for automatically defining set of categories for document classification. An example workflow for automatically defining set of categories for document classification is schematically illustrated by FIG. 1. As shown in FIG. 1, the input documents 100 are fed to the image feature extraction functional module 110, text feature extraction functional module 120, and document layout feature extraction functional module 130, which process each input document in order to produce, respectively, the vector of image features 140, vector of text features 150, and vector of document layout features 160. “Functional module” herein refers to one or more software programs executed by a general purpose or specialized data processing device for implementing the specified functionality.

In an illustrative example, the image feature extraction functional module may be implemented by a convolutional neural network (CNN). In another illustrative example, the image feature extraction functional module may be implemented by an autoencoder. The text feature extraction functional module may represent each input document text by a histogram which is calculated on a set of clusterized word embeddings. The document layout feature extraction functional module may apply, to each input document, a document layout template, which includes definitions of coordinates, sizes, and other attributes of one or more document layout features, in order to produce feature vectors encode the types, sizes, and other attributes of the document layout features defined by the template and detected in the input document, as described in more detail herein below.

At least subsets of elements the image feature vector, text feature vector, and/or document layout feature vector are concatenated into the feature vector 170 representing the input document, which may then be normalized by the normalization functional module 180 in order to prepare the feature vector for further processing (e.g., by reducing the dimension of the vector, applying a linear transformation to the vector, etc.). The set of feature vectors corresponding to the set of input documents is then fed to clusterization functional module 190. Document categories corresponding to cluster definitions 195 produced by the clusterization functional module 190 may be utilized for training one or more document classifiers, as described in more detail herein below. Various aspects of the above referenced methods and systems are described in details herein below by way of examples, rather than by way of limitation.

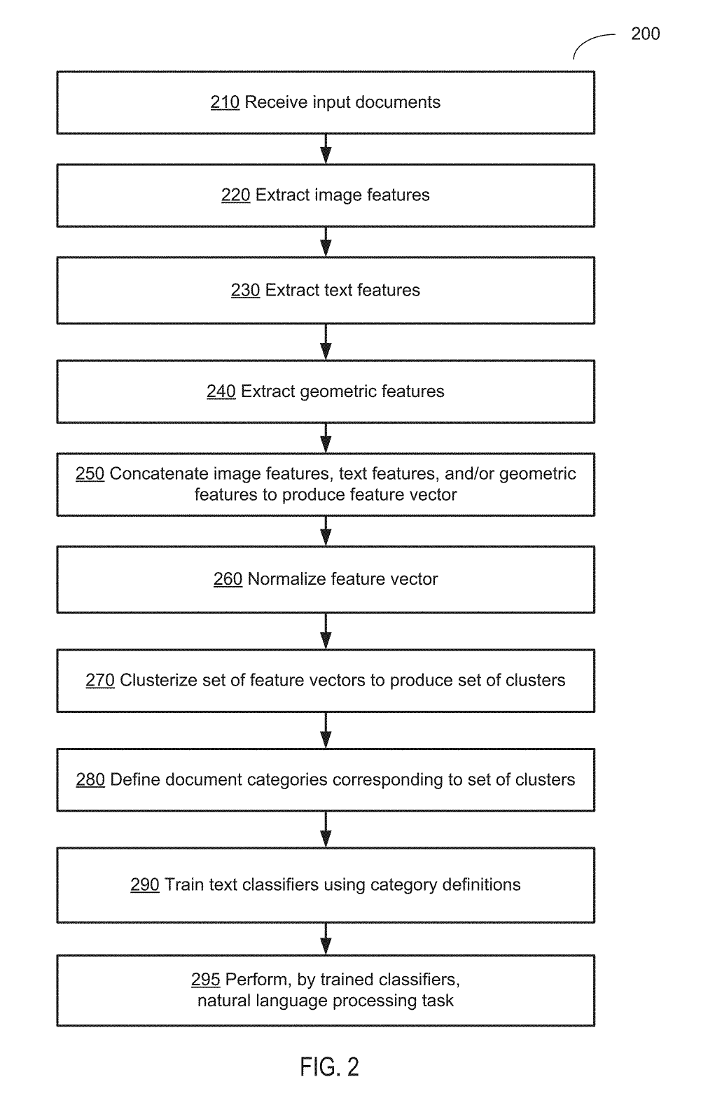

FIG. 2 depicts a flow diagram of one illustrative example of a method of automatically defining set of categories for document classification, in accordance with one or more aspects of the present disclosure. Method 200 and/or each of its individual functions, routines, subroutines, or operations may be performed by one or more processors of the computer system (e.g., computer system 1000 of FIG. 10) implementing the method. In certain implementations, method 200 may be performed by a single processing thread. Alternatively, method 200 may be performed by two or more processing threads, each thread implementing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other.

At block 210, a computer system implementing the method may receive a plurality of documents (e.g., represented by document images and texts produced by applying optical character recognition (OCR) methods to the document images). Each input document may be processed by performing the operations described herein below with references to blocks 220-260.

At block 220, the computer system may extract document image features. In various illustrative examples, image feature extraction may involve applying, to each input document image, a convolution neural network (CNN) or an autoencoder.

The CNN output, which is represented by a vector, each element of which specifies a degree of association of the input document image with a class identified by an index of the element in the output vector, may be utilized for pre-training the CNN on a training data set that includes a plurality of images with known classification. In operation of the method 100, after the CNN is pre-trained, a vector of image features may be received from the output of one or more convolutional and/or pooling layers of the CW as described in more detail herein below.

A CNN is a computational model based on a multi-staged algorithm that applies a set of pre-defined functional transformations to a plurality of inputs (e.g., image pixels) and then utilizes the transformed data for performing pattern recognition. A CNN may be implemented as a feed-forward artificial neural network in which the connectivity pattern between its neurons is inspired by the organization of the animal visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation, which involves applying a convolution filter (i.e., a matrix) to each image element represented by one or more pixels.

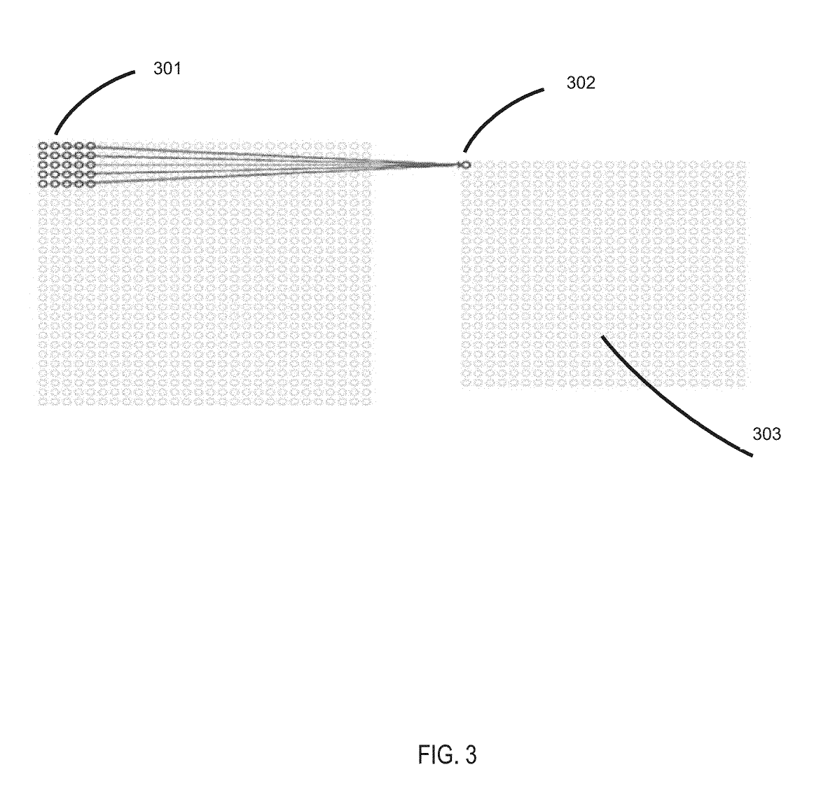

In an illustrative example, a CNN may include multiple layers of various types, including convolution layers, non-linear layers (e.g., implemented by rectified linear units (ReLUs)), pooling layers, and classification (fully-connected) layers. A convolution layer may extract features from the input image by applying one or more trainable pixel-level filters to the input image. As schematically illustrated by FIG. 3, a pixel-level filter 301 may be represented by a matrix of integer values, which is convolved across the dimensions of the input image 300 in order to compute dot products between the entries of the filter 301 and the input image 300 at each spatial position, thus producing a feature map 303 that represents the responses of the filter at every spatial position 302 of the input image.

A non-linear operation may be applied to the feature map produced by the convolution layer. In an illustrative example, the non-linear operation may be represented by a rectified linear unit (ReLU) which replaces with zeros all negative pixel values in the feature map. In various other implementations, the non-linear operation may be represented by a hyperbolic tangent function, a sigmoid function, or by other suitable non-linear function.

A pooling layer may perform subsampling in order to produce a reduced resolution feature map while retaining the most relevant information. The subsampling may involve averaging and/or determining maximum value of groups of pixels.

In certain implementations, convolution, non-linear, and pooling layers may be applied to the input image multiple times prior to the results being transmitted to a classification (fully-connected) layer. Together these layers extract the useful features from the input image, introduce non-linearity, and reduce image resolution while making the features less sensitive to scaling, distortions, and small transformations of the input image. The output from the convolutional and/or pooling layers represent the vector of image features which is utilized by subsequent operations of method 100.

The output of the classification layer, which is represented by a vector, each element of which specifies a degree of association of the input document image with a class identified by an index of the element in the output vector, may be utilized for pre-training the CNN. In an illustrative example, the classification layer may be represented by an artificial neural network that comprises multiple neurons. Each neuron receives its input from other neurons or from an external source and produces an output by applying an activation function to the sum of weighted inputs and a trainable bias value. A neural network may include multiple neurons arranged in layers, including the input layer, one or more hidden layers, and the output layer. Neurons from adjacent layers are connected by weighted edges. The term “fully connected” implies that every neuron in the previous layer is connected to every neuron on the next layer.

The edge weights are defined at the network training stage based on a training dataset that includes a plurality of images with known classification. In an illustrative example, all the edge weights are initialized to random values. For every input in the training dataset, the neural network is activated. The observed output of the neural network is compared with the desired output specified by the training data set, and the error is propagated back to the previous layers of the neural network, in which the weights are adjusted accordingly. This process may be repeated until the output error falls below a predetermined threshold.

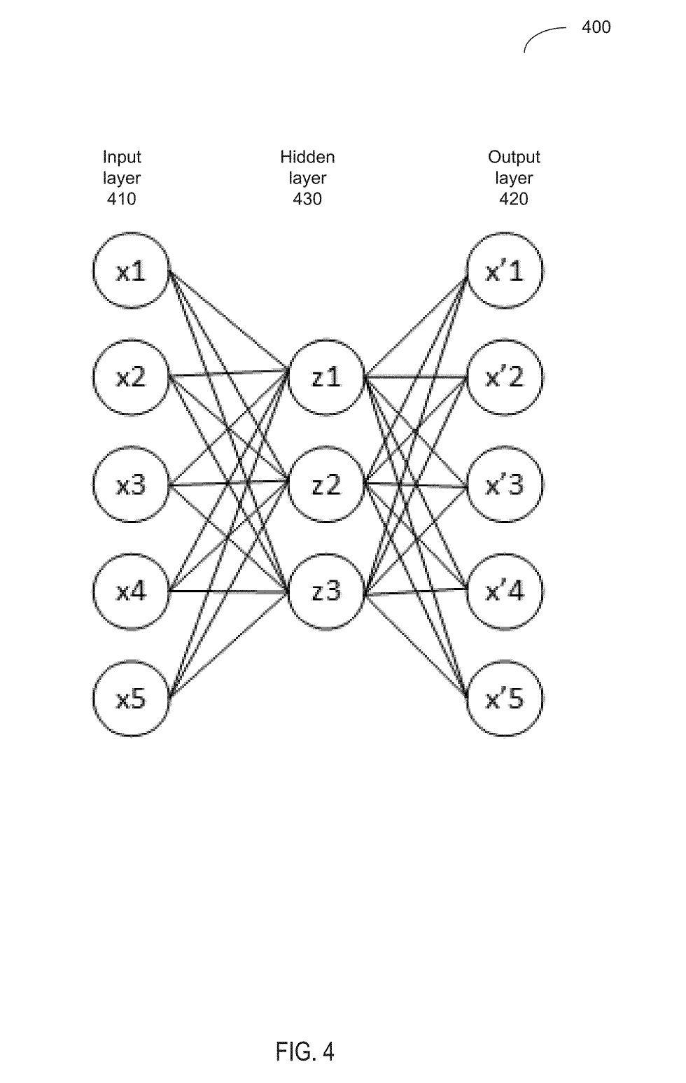

As noted herein above, image feature extraction may also be performed by an autoencoder. FIG. 4 schematically illustrates a structure of an example autoencoder operating in accordance with one or more aspects of the present disclosure. As shown in FIG. 4, the autoencoder 400 may be represented by a feed-forward, non-recurrent neural network including an input layer 410, an output layer 420 and one or more hidden layers 430 connecting the input layer 410 and the output layer 420. The output layer 420 may have the same number of nodes as the input layer 410, such that the network 400 may be trained, by an unsupervised learning process, to reconstruct its own inputs.

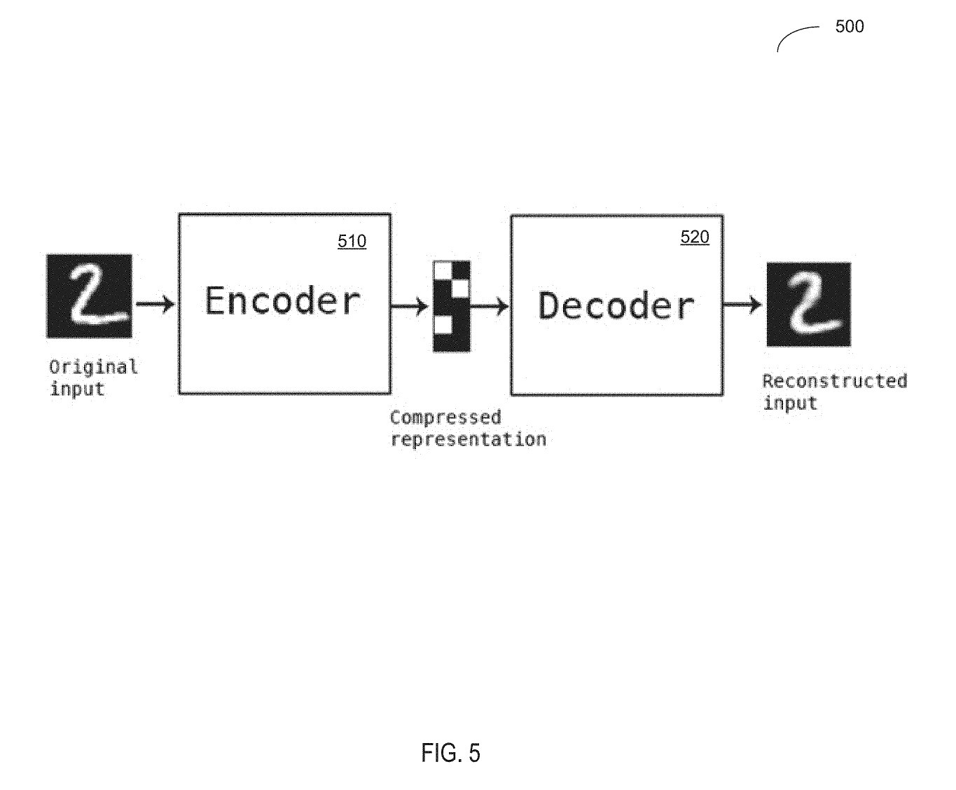

FIG. 5 schematically illustrates operation of an example autoencoder, in accordance with one or more aspects of the present disclosure. As shown in FIG. 5, the example autoencoder 500 may include an encoder stage 510 and a decoder stage 520. The encoder stage 510 of the autoencoder may receive the input vector x and map it to the latent representation z, and the dimension of which is significantly less than that of the input vector:

z=σ(Wx+b),

where σ is the activation function, which may be represented by a sigmoid function or by a rectifier linear unit,

W is the weight matrix, and

b is the bias vector.

The decoder stage 520 of the autoencoder may map the latent representation z to the reconstruction vector x′ having the same dimension as the input vector x:

X′=σ′ (W′z+b′).

The autoencoder may be trained to minimize the reconstruction error:

L(x, x′)=∥x−x′∥²=∥x−σ′(W′(σ(Wx|b))|b′)∥²,

where x may be averaged over the training data set.

As the dimension of the hidden layer is significantly less than that of the input and output layers, the autoencoder compresses the input vector by the input layer and then restores is by the output layer, thus detecting certain inherent or hidden features of the input data set.

Unsupervised learning of the autoencoder may involve, for each input vector x, performing a feed-forward pass in order to obtain the output x′, measuring the output error reflected by the loss function L(x, x′), and back-propagating the output error through the network in order to update the dimension of the hidden layer, the weights, and/or activation function parameters. In an illustrative example, the loss function may be represented by the binary cross-entropy function. The training process may be repeated until the output error is below a predetermined threshold.

Referring again to FIG. 2, at block 230, the computer system may extract text features. The document text may be produced, e.g., by applying OCR methods to the document image. In certain implementations, text feature extraction may involve representing each input document text by a histogram which is calculated on a set of clusterized word embeddings. “Word embedding” herein shall refer to a vector of real numbers which may be produced, e.g., by a neural network implementing a mathematical transformation from a space with one dimension per word to a continuous vector space with much lower dimension.

In an illustrative example, a pre-defined set of embeddings, which is built on a large corpus of words, may be clusterized into a relatively small number of clusters (e.g., 256 clusters) using a chosen clusterization metric. A histogram representing the input text may be initialized with zero values for all historgram bins, such that each bin corresponds to a respected cluster of the set of pre-defined clusters. Then, for each word of the input text its context vector is determined, and a cluster is identified which is nearest to the context vector by the chosen clusterization metric. The histogram bin corresponding to the identified cluster is incremented by a pre-defined number. The output of block 230 may thus be represented by a vector, each element of which contains the number stored by the histogram bin having the index equal to the index of the vector element. Alternatively, the output of block 230 may be represented by a vector of term frequency inverse document frequency (TF-IDF) values calculated on the set of clusters.

Term frequency (TF) represents the frequency of occurrence of a given word (or a context vector representation of the word) in the document:

tf(t,d)=nₜ/Σnₖ

where t is the word identifier,

d is the document identifier,

nₜ is the number of occurrences of the word t within document d, and

Σnₖ is the total number of words within document d.

Inverse document frequency (IDF) is defined as the logarithmic ratio of the number of texts in the corpus to the number of documents containing the given word:

idf(t, D)=log └|D|/|{di ∈ D|t ∈di}|┘

where D is the text corpus identifier,

|D| is the number of documents in the corpus, and

{di c D|t c di} is the number of documents of the corpus D which contain the word t.

Thus, TF-IDF may be defined as the product of the term frequency (TF) and the inverse document frequency (IDF):

tf−idf(t, d, D)=tf(t, d)*idf(t, D)

TF-IDF would produce larger values for words that are more frequently occurring in one document that on other documents of the corpus.

As noted herein above, each word of the input document may be represented by a cluster of the pre-defined set of clusters, such that the cluster representing the word is the nearest, by the chosen clusterization metric, to the context vector corresponding to the input document word. Therefore, in the above calculations of the TF-IDF values, words may be replaced with clusters of the pre-defined set of clusters. Thus, the output of block 230 may be represented by a vector, each element of which contains the TF-IDF value of the cluster identified by the index equal to the index of the vector element. Accordingly, the text corpus may be represented by a matrix, each cell of which stores the TF-IDF value of the cluster identified by the column index in the document identified by the row index.

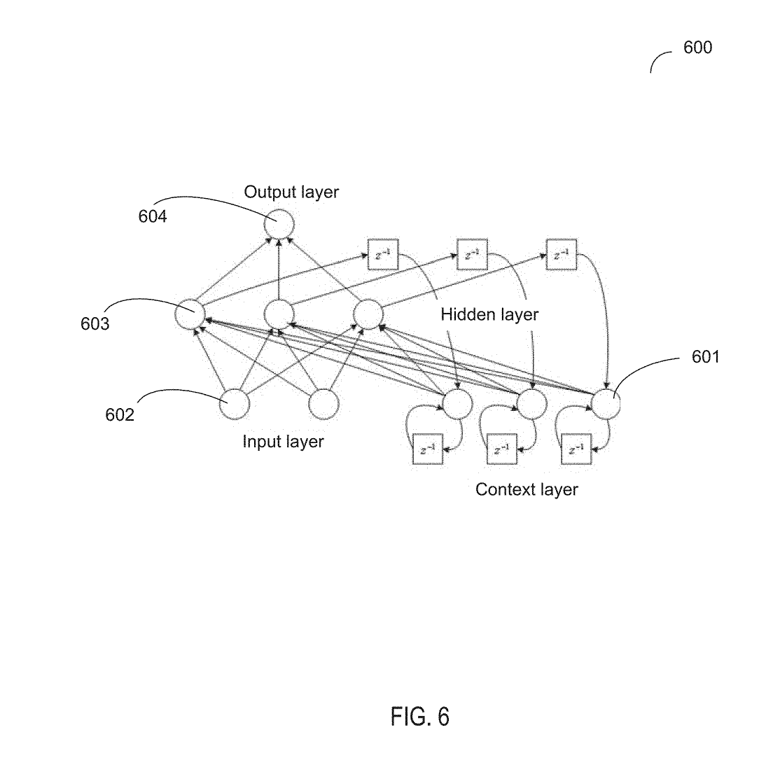

In certain implementations, the context vectors representing the words may be produced by a recurrent neural network. Recurrent neural networks are capable of maintaining the network state reflecting the information about the inputs which have been processed by the network, thus allowing the network to use their internal state for processing subsequent inputs. As schematically illustrated by FIG. 6, the recurrent neural network 600 receives an input vector by the input layer 602, processes the input vector by the hidden layer 603, stores the network state by the context layer 601, and produces the output vector by the output layer 604. The network state stored by the context layer 601 would then be utilized for processing the subsequent input vectors. In various illustrative example, extracting context vectors may involve feeding, to the input of the recurrent neural network 600, sequences of input text words, group of words (e.g., sentences or paragraphs), or sequences of individual symbols. The latter option of calculating the context vectors corresponding to sequences of individual symbols may be particularly useful for situations when the input text, which is produced by applying OCR methods to an input document image, may suffer from multiple recognition errors and thus contain a relatively large number of groups of symbols which are not dictionary words.

Referring again to FIG. 2, at block 240, the computer system may process each input document in order to extract document layout features. In certain implementations, the document layout features may be extracted based on user-provided mark-up, which may graphically emphasize certain elements, text fragments or individual words, e.g., by underlining, highlighting, encircling, placing in bounding boxes, etc. In various illustrative examples, the mark-up may graphically emphasize a logotype, a document title or subtitle, etc. Therefore, document layout features may represent information about the user-emphasized text fragments, including their coordinates in the text and their representation by embeddings or context vectors.

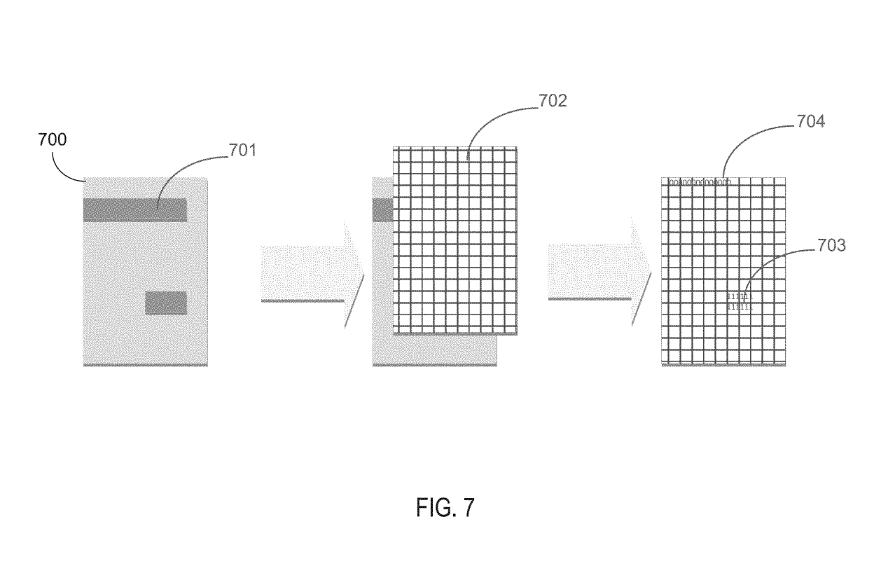

In certain implementations, the document layout features may reflect presence or absence of certain graphical elements of the input document, e.g., pre-defined image fragments (such as logotypes), pre-defined words or group of words, barcodes, document margins, graphic dividers, etc. As schematically illustrated by FIG. 7, a document layout template 702, which includes definitions of coordinates, sizes, and other attributes of one or more document layout features, may be matched against the input document 700 containing document layout features 701 in order to produce feature vectors 703 and 704 encode the types, sizes, and other attributes of the document layout features defined by the template and detected in the input document. In certain implementations, multiple document layout templates may consecutively be matched against to the input document in order to extract multiple sets of document layout features.

Referring again to FIG. 2, at block 250, the computer system may, for each input document, concatenate at least subsets of elements of the image feature vector, text feature vector, and/or document layout feature vector in order to produce the feature vector representing the input document. In certain implementations, the feature vector may further include morphological, lexical, syntactic, semantic, and/or other features of the input document.

At block 260, the computer system may normalize the feature vector, e.g., in order prepare it for further processing. In certain implementations, the feature vector may be normalized by the Principal Component Analysis (PCA), which is a statistical procedure that uses an orthogonal transformation in order to convert a set of observations of possibly correlated variables into a set of values of linearly uncorrelated variables called principal components. PCA may be thought of as fitting an n-dimensional ellipsoid to the data, where each axis of the ellipsoid represents a principal component.

PCA is mathematically defined as an orthogonal linear transformation that transforms the data to a new coordinate system such that the greatest variance by some projection of the data comes to lie on the first axis (called the first principal component), the second greatest variance on the second axis, and so on. This transformation is defined in such a way that the first principal component has the largest possible variance (that is, accounts for as much of the variability in the data as possible), and each succeeding component is orthogonal to the preceding components and has the highest possible variance.

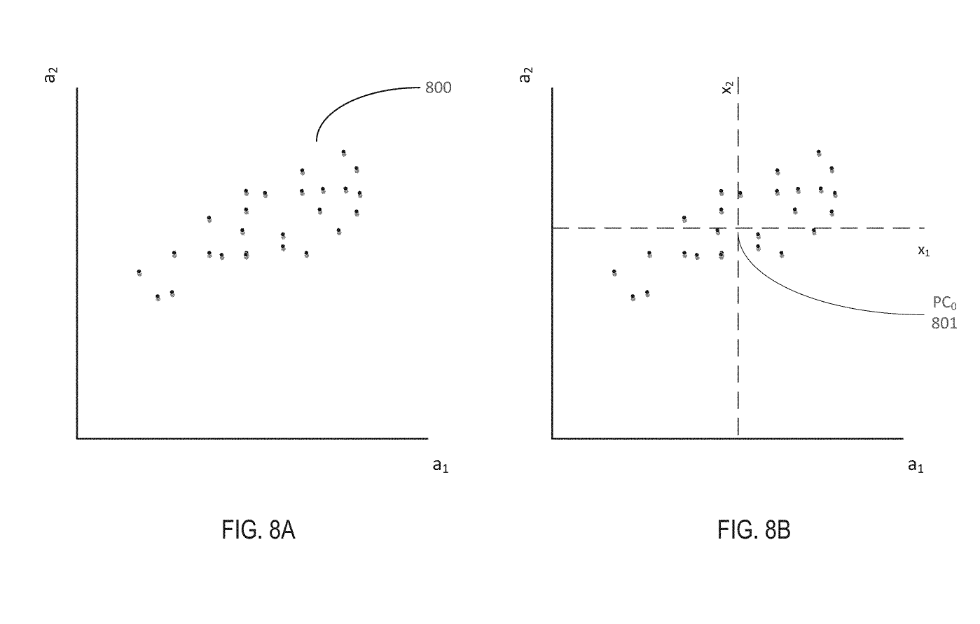

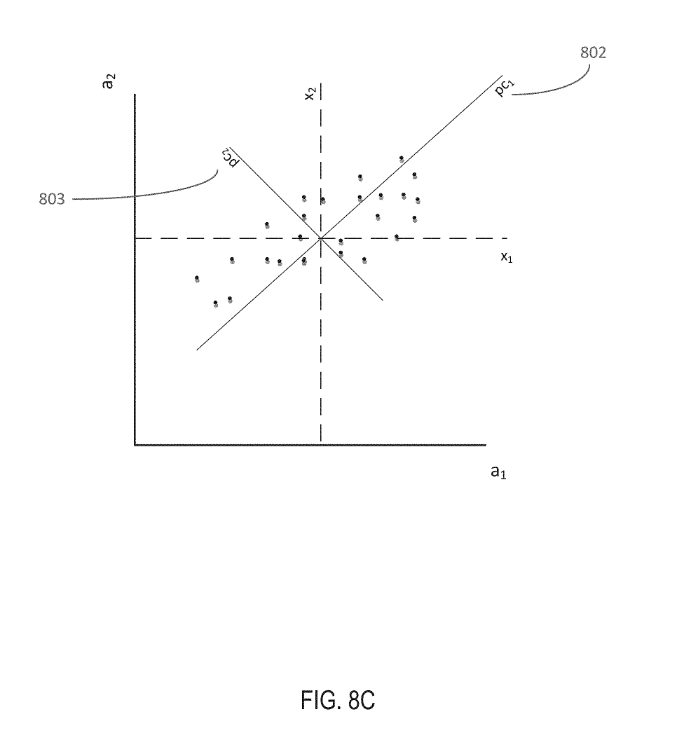

Accordingly, PCA allows reducing the dimension of the input vectors without losing the most relevant information. As schematically illustrated by FIGS. 8A-8B, performing the PCA involves identifying the values of PC₀, PC₁, and PC₂ such that the vector values would have the greatest possible variability. In FIGS. 8A-8C, the input set of two-dimensional vectors is illustrated by the cloud of points in the two-dimensional space. The method may involve identifying the center of the cloud, which becomes the new origin PC₀ (801). Then, the axis corresponding to the direction of the greatest data variability is identified, which becomes the first principal component PC₁ (802). Finally, another axis PC₂ (803) is identified which is perpendicular to the first axis, in order to reflect the remaining data variability. Thus, the dimension of the input data vector is reduced.

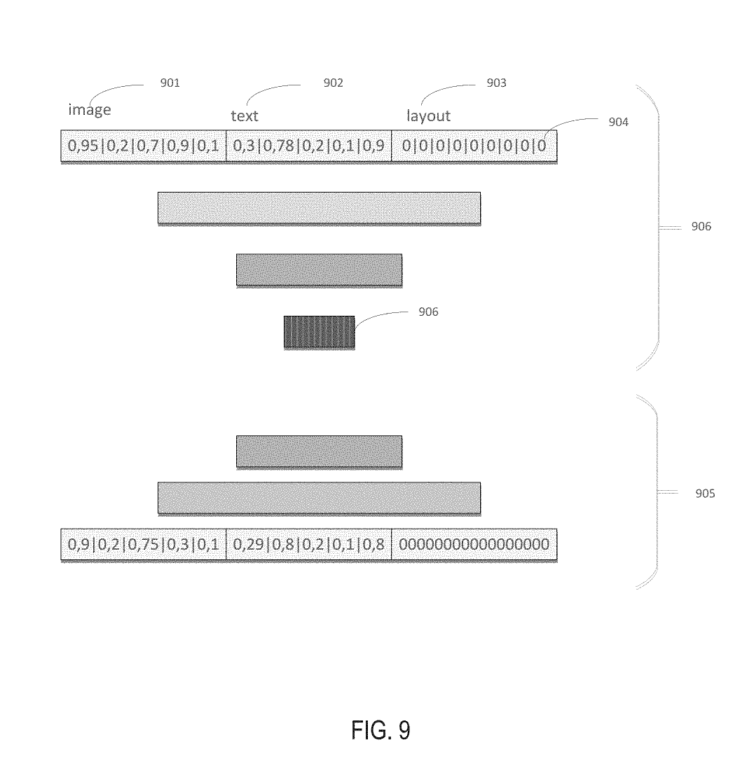

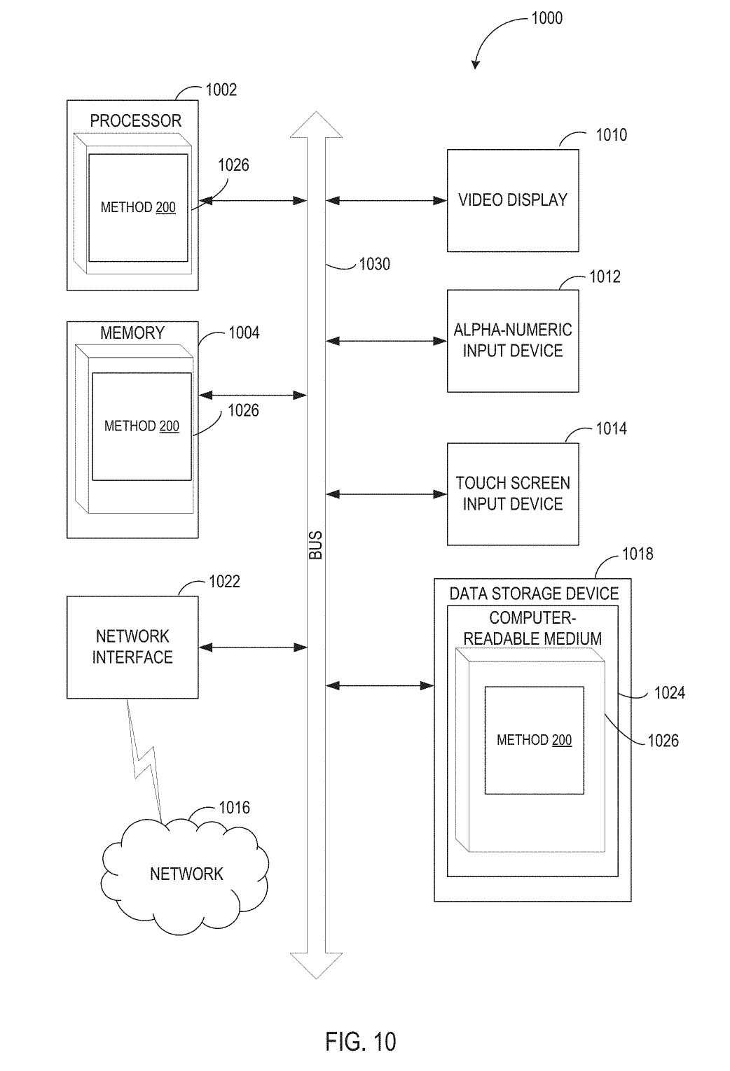

Alternatively, as schematically illustrated by FIG. 9, the feature vector may be normalized by an autoencoder, the input of which receives the concatenated vector of image features 901, text features 902, and layout features 903. If a set of features is missing from the concatenated vector, the corresponding vector elements may be filled with zeroes 904. The output layer 905 is utilized for pre-training the autoencoder. After the pre-training is complete, the normalized representation of the input feature vector may be received from the intermediate layer 906.

Alternatively, the feature vector may be normalized by other methods, such as Latent Semantic Analysis (PLSA), Probabilistic Latent Semantic Analysis (PLSA), or chi-squared distribution.

Referring again to FIG. 2, at block 270, the computer system may produce a plurality of feature clusters by clusterizing the set of normalized feature vectors extracted from the plurality of input documents. In an illustrative example, cluserizaiton may be performed by K-means method, which involves partitioning n observations into k clusters in which each observation belongs to the cluster with the nearest mean, serving as a prototype of the cluster. Thus, clusterizaiton may involve randomly selecting the cluster centers and iteratively associating the feature vectors with the nearest clusters and re-calculating the cluster centers until the clusters are formed.

Alternatively, other clusterization methods may be employed for clusterizing the set of normalized feature vectors, e.g., Density-Based Spatial Clustering of Applications with Noise (DBSCAN).

Referring again to FIG. 2, at block 280, the computer system may define a plurality of document categories, such that each document category is defined by a respective feature cluster of the plurality of feature clusters. In other words, each document category would include documents that are nearest, by the chosen clusterization metric, to the respective feature cluster.

At block 290, the computer system may utilize the document classification categories produced by the output of block 280 for training one or more classifiers in order to produce a value reflecting a degree of association of an input document with one or more document categories of the plurality of document categories. In certain implementations, the classifier may be represented by a Support Vector Machine (SVM) classifier, Gradient Boost (GBoost) classifier, or Radial Basis Function (RBF) classifier. Training the classifier may involve iteratively identify the values of certain parameters of the classifier that would optimize a chosen fitness function. In an illustrative example, the fitness function may reflect the number of natural language texts of the validation data set that would be classified correctly using the specified values of the classifier parameters. In certain implementations, the fitness function may be represented by the F-score, which is defined as the weighted harmonic mean of the precision and recall of the test:

F=2*P*R/(P−R),

where P is the number of correct positive results divided by the number of all positive results, and

R is the number of correct positive results divided by the number of positive results that should have been returned.

At block 295, the computer system may utilize the trained classifiers to perform one or more natural language processing operations or tasks. Examples natural language processing tasks include detecting semantic similarities, search result ranking, determination of text authorship, spam filtering, selecting texts for contextual advertising,etc. Upon completing the operations of block 295, the method may terminate.

FIG. 10 illustrates a diagram of an example computer system 1000 which may execute a set of instructions for causing the computer system in order to perform any one or more of the methods discussed herein. The computer system may be connected to other computer system in a LAN, an intranet, an extranet, or the Internet. The computer system may operate in the capacity of a server or a client computer system in client-server network environment, or as a peer computer system in a peer-to-peer (or distributed) network environment. The computer system ay be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 1000 includes a processor 1002, a main memory 1004 (e.g., read-only memory (ROM) or dynamic random access memory (DRAM)), and a data storage device 1018, which communicate with each other via a bus.

Processor 1002 may be represented by one or more general-purpose computer systems such as a microprocessor, central processing unit, or the like. More particularly, processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 1002 may also be one or more special-purpose computer systems such as an application specific integrated circuit (ASIC), a field programmable gate array (FPGA), a digital signal processor (DSP), network processor, or the like. Processor 1002 is configured to execute instructions 1026 for performing the operations and functions discussed herein.

Computer system 1000 may further include a network interface device 1022, a video display unit 1010, an alpha-numeric device 1012 (e.g., a keyboard), and a touch screen input device 1014.

Data storage device 1018 may include a computer-readable storage medium 1024 on which is stored one or more sets of instructions 1026 embodying any one or more of the methodologies or functions described herein. Instructions 1026 may also reside, completely or at least partially, within main memory 1004 and/or within processor 1002 during execution thereof by computer system 1000, main memory 1004 and processor 1002 also constituting computer-readable storage media. Instructions 1026 may further be transmitted or received over network 1016 via network interface device 1022.

In certain implementations, instructions 1026 may include instructions of method 200 of automatically defining set of categories for document classification, in accordance with one or more aspects of the present disclosure. While computer-readable storage medium 1024 is shown in the example of FIG. 10 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not he limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may he specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
producing, by a computer system, a plurality of image features by processing images of a plurality of documents;
producing a plurality of text features by processing texts of a plurality of documents;
producing a plurality of feature vectors, wherein each feature vector of the plurality of feature vectors comprises at least one of: a subset of the plurality of image features and a subset of the plurality of text features;
clusterizing the plurality feature vectors to produce a plurality of clusters;
defining a plurality of document categories, such that each document category of the plurality of document categories is defined by a respective feature cluster of the plurality of feature clusters; and
training a classifier to produce a value reflecting a degree of association of an input document with one or more document categories of the plurality of document categories.

2. The method of claim 1, further comprising:
producing a plurality of document layout features by processing the plurality of documents, wherein each feature vector of the plurality of feature vectors further comprises at least a subset of the plurality of document layout features.

3. The method of claim 1, wherein producing the plurality of feature vectors further comprises:
normalizing the plurality of feature vectors.

4. The method of claim 1, wherein producing the plurality of image features further comprises:
processing the plurality of document images by a convolutional neural network (CNN); and
producing the plurality of image features from one or more hidden layers of the CNN.

5. The method of claim 1, wherein producing the plurality of image features further comprises:
processing the plurality of document images by an autoencoder.

6. The method of claim 1, wherein producing a plurality of text features further comprises:
producing a plurality of context vectors representing a document text; and
associating each context vector of the plurality of context vectors with a cluster of a pre-defined set of clusters of text features.

7. The method of claim 1, wherein producing the plurality of feature vectors further comprises:
concatenating at least a subset of the plurality of image features and at least a subset of the plurality of text features.

8. The method of claim 1, wherein clusterizing the plurality feature vectors further comprises:
partitioning the plurality of feature vectors into the plurality of clusters, such that each feature vector belongs to a cluster with a nearest mean value.

9. The method of claim 1, further comprising:
utilizing the classifier to perform a natural language processing task.

10. A system, comprising:
a memory;
a processor, coupled to the memory, the processor configured to:
produce a plurality of image features by processing images of a plurality of documents;
produce a plurality of text features by processing texts of a plurality of documents;
produce a plurality of feature vectors, wherein each feature vector of the plurality of feature vectors comprises at least one of: a subset of the plurality of image features and a subset of the plurality of text features;
clusterize the plurality feature vectors to produce a plurality of clusters;
define a plurality of document categories, such that each document category of the plurality of document categories is defined by a respective feature cluster of the plurality of feature clusters; and
train a classifier to produce a value reflecting a degree of association of an input document with one or more document categories of the plurality of document categories.

11. The system of claim 10, wherein the processor is further configured to:
produce a plurality of document layout features by processing the plurality of documents,
wherein each feature vector of the plurality of feature vectors further comprises at least a subset of the plurality of document layout features.

12. The system of claim 11 wherein producing the plurality of image features further comprises:
processing the plurality of document images by a convolutional neural network (CNN); and
producing the plurality of image features from one or more hidden layers of the CNN.

13. The system of claim 10, wherein producing a plurality of text features further comprises:
producing a plurality of context vectors representing a document text; and
associating each context vector of the plurality of context vectors with a cluster of a pre-defined set of clusters of text features.

14. The system of claim 10, wherein producing the plurality of feature vectors further comprises:
concatenating at least a subset of the plurality of image features and at least a subset of the plurlaity of text features.

15. The system of claim 11, further comprising:
utilizing the classifier to perform a natural language processing task.

16. A non-transitory computer-readable storage medium comprising executable instructions that, when executed by a computer system, cause the computer system to:
produce a plurality of image features by processing images of a plurality of documents;
produce a plurality of text features by processing texts of a plurality of documents;
produce a plurality of feature vectors, wherein each feature vector of the plurality of feature vectors comprises at least one of: a subset of the plurality of image features and a subset of the plurality of text features;
clusterize the plurality feature vectors to produce a plurality of clusters;
define a plurality of document categories, such that each document category of the plurality of document categories is defined by a respective feature cluster of the plurality of feature clusters; and
train a classifier to produce a value reflecting a degree of association of an input document with one or more document categories of the plurality of document categories.

17. The non-transitory computer-readable storage medium of claim 16, further comprising executable instructions to cause the computer system to:
produce a plurality of document layout features by processing the plurality of documents,
wherein each feature vector of the plurality of feature vectors further comprises at least a subset of the plurality of document layout features.

18. The non-transitory computer-readable storage medium of claim 16, wherein producing the plurality of image features further comprises:
processing the plurality of document images by a convolutional neural network (CNN); and
producing the plurality of image features from one or more hidden layers of the CNN.

19. The non-transitory computer-readable storage medium of claim 16, wherein producing the plurality of feature vectors further comprises:
concatenating at least a subset of the plurality of image features and at least a subset of the plurlaity of text features.

20. The non-transitory computer-readable storage medium of claim 16, further comprising:
utilizing the classifier to perform a natural language processing task.
